(19) United States
(12) Patent Application Publication
(10) Pub. No.: US 2026/0034821 A1
(43) Pub. Date: Feb. 5, 2026

(54) METHOD AND SYSTEM FOR OBTAINING A CUSTOMIZED OPTICAL ARTICLE HAVING AT LEAST ONE PRE-DETERMINED OPTICAL PROPERTY

(71) Applicant: Essilor International, Charenton-le-Pont (FR)

(72) Inventors: Bahhar YESILKAYA, Charenton-le-Pont (FR); Tony DANTAS DE MORAIS, Charenton-le-Pont (FR)

(21) Appl. No.: 18/998,222

(22) PCT Filed: Jul. 26, 2023
(86) PCT No.: PCT/EP2023/070766

§ 371 Date: Jan. 24, 2025

(30) Foreign Application Priority Data
Jul. 26, 2022 (EP) 22306114.4

(51) Int. Cl. B41M 5/025; B29D 11/00; B41J 2/005; B41J 2/01; G01M 11/02; G02C 7/02; G06K 15/02

(52) U.S. Cl. CPC B41M 5/0256; B41J 2/0057; G01M 11/0285; G06K 15/027; B29D 11/00923; B41J 2002/012; G02C 7/02; G06K 2215/101

(57) ABSTRACT

The invention relates to a method and system for obtaining a customized optical article having at least one predetermined optical property in visible and/or invisible light domain(s) selected from absorbance and transmittance, by thermal transfer via a sublimation technique from a printed support comprising a support and at least one ink (C, M, Y) printed on the support according to an inking level, the at least one ink comprising at least one sublimable dye selected from visible dyes, invisible dyes and mixtures thereof. The invention particularly applies to an ophthalmic lens part, even though it may concern any optical article to be tinted and/or provided with an invisible light absorber such as IR, UV and/or blue light absorbers. The method comprises controlling the inking level of the at least one ink (C, M, Y) to obtain said customized optical article, by using an experimentally determined variation law of the at least one predetermined optical property as a function of the inking level of the at least one ink.

### CROSS-REFERENCE TO RELATED APPLICATIONS

This application is a national phase application under 35 U.S.C. § 371 of International Application No. PCT/EP2023/070766 filed 26 Jul. 2023, which claims priority to European Patent Application No. 22306114.4 filed 26 Jul. 2022. The entire contents of each of the above-referenced disclosures is specifically incorporated by reference herein without disclaimer.

### FIELD OF THE INVENTION

The present invention relates to a method and a system for obtaining a customized optical article having at least one predetermined optical property in visible and/or invisible light domain(s), by a thermal transfer via a sublimation technique from a support printed with at least one visible and/or invisible ink. The invention particularly applies to an ophthalmic lens part, even though it may concern any optical article to be tinted by visible dyes and/or provided with an invisible light absorber such as IR, UV or blue light absorbers.

### DESCRIPTION OF RELATED ART

In a known manner, most tinting techniques recently implemented for ophthalmic lenses may include:
dip-tinting methods, according to which the lenses are tinted by dipping into an aqueous tinting bath, and
tinting methods by thermally transferring colored dyes from a printed paper onto the lenses by successive sublimation and imbibition steps, see examples of WO 2020/064640 A1 in page 15, lines 1-7 for the disclosure of such a technique where a mixture of three sublimable dyes is printed on a specific paper, then dyes are transferred from the specific paper to the concave side of the lens by sublimation, and the lens is finally heated so that dyes diffuse in the mass of the lens by imbibition.

A major drawback of tinting ophthalmic lenses by a sublimation and imbibition method resides in that this method involves an intrinsic dispersion, very often requiring to compensate for color variations from one pair of lenses to another one while manufacturing the lenses, by using a retouching dip-tinting step to guarantee the color conformity to the customers.

WO 2020/025595 A1 discloses a method and system for determining a lens of customized color, said method comprising the steps of determining a target colorimetric data set; providing access to a database comprising data representing colors; using a plurality of simulation modules to calculate, based on said data from the database, a plurality of simulated colorimetric data of the lens substrate combined with a mixture of dyes of determined dye(s) combination, composition and amount or with a multilayer stack as a function of determined layers composition and thicknesses; and, color matching the plurality of simulated colorimetric data with the target colorimetric data set so as to determine one or a plurality of combinations of said lens substrate with a determined mixture of dyes or with a determined multilayer stack.

WO 2020/025595 A1 does not relate to a tinting method by sublimation from a printed paper and imbibition, no printed paper being used for measuring an optical parameter thereon.

### SUMMARY OF THE INVENTION

An object of the invention is to provide a method for obtaining a customized optical article comprising a main surface having at least one predetermined (i.e. desired) optical property in visible and/or invisible light domain(s) selected from absorbance and transmittance, by a thermal transfer via a sublimation technique from a printed support comprising a support and at least one ink printed on the support according to an inking level, the at least one ink comprising at least one sublimable dye selected from visible dyes, invisible dyes and mixtures thereof, which allows to dispense with a retouching step for the optical article, thus avoiding the above-mentioned dip-tinting final step.

For that purpose, the method according to the invention comprises controlling the inking level of the at least one ink to obtain said customized optical article, by using an experimentally determined variation law of the at least one predetermined optical property as a function of the inking level of the at least one ink.

It will be noted that the method of the invention thus allows to obtain said customized optical article just by analyzing/modifying the printed support before implementing the sublimation step, this analyzing/modifying operation directly allowing to obtain the at least one predetermined optical property for the optical article finally obtained without having to implement any correcting step to adjust its optical property(ies). As a consequence, no dip-tinting retouching final step is required in addition to the thermal transfer process to guarantee the prescribed optical property(ies) to the customers (e.g. the color and/or invisible light absorbing requirements), thanks to the method of the invention which therefore allows to compensate for variations or dispersion of the inking level on the support.

One can thus dispense with any final retouching step, by assuring that the at least one ink is obtained at the correct inking level on the printed support, so as to match the target absorbance and/or transmittance values that are predetermined for the optical article. In other words, the customized optical article advantageously only results from the inking level of the at least one ink.

As explained below, the method of the invention not only applies to ophthalmic lens parts, but also to any optical article to be tinted and/or provided with an invisible light absorber, and which may not be in the ophthalmic domain.

It will also be noted that the method of the invention generally applies to a support which is opaque to visible light, being for example being made of paper or cardboard.

It will further be noted that in the case of a plurality of inks to be printed (i.e. several visible dyes and/or several invisible dyes), such inks must be separately printed on the support (i.e. not forming a mixture of inks) and that the inking level of each ink must then be separately controlled, as will be detailed in the examples below.

According to another feature of the invention, said variation law of the at least one predetermined optical property as a function of the inking level of the at least one ink may be experimentally determined by using in combination:
a first experimental correlation between an optical parameter of the at least one ink on the printed support and the inking level thereof, the optical parameter of the at least one ink being selected from its K/S ratio of absorbance coefficient to scattering coefficient, its optical density, its colorimetric coefficients such as its colorimetric lightness L* and colorimetric coefficients a* and b*, and combinations thereof, and
a second experimental correlation between at least one predicted optical property of the customized optical article, selected from maximum absorbance and minimum transmittance values of the optical article and measured at at least one given wavelength of the visible and/or invisible light domain(s), and said optical parameter of the at least one ink.

Preferably, the optical parameter of the at least one ink which is used in both the first and second experimental correlations is the K/S ratio of absorbance coefficient K to scattering coefficient S of the at least one printed ink, as defined by the Kubelka-Munk relationship:

K/S=(1−R∞)²/2R∞, where R∞ denotes the diffuse reflectance of an infinitely thick layer.

Also preferably, the at least one predicted optical property of the customized optical article is its maximum absorbance value.

Advantageously, according to the above feature of the invention:
the first experimental correlation may be approximated to be a linear one of the type y=a x+b, where y denotes the optical parameter of the at least one ink on the printed support, x denotes the inking level of the at least one ink, and a, b are constants representative of the at least one ink, and
the second experimental correlation may be approximated to be a linear one of the type y=a′ x+b′, where y denotes the at least one predicted optical property of the customized optical article, x denotes the optical parameter of the at least one ink on the printed support, and a′, b′ are constants representative of the at least one ink.

More preferably, the optical parameter of the at least one ink which is used in both the first and second experimental correlations is the above-defined K/S ratio thereof, and the at least one predicted optical property of the customized optical article is its maximum absorbance value.

According to a preferred embodiment of the invention which may be combined to any of the above features, the method comprises compensating the inking level for the at least one ink, by means of said first experimental correlation and available data of reference optical articles which were beforehand manufactured by said thermal transfer from a similar printed support, the reference optical articles each comprising a main surface having at least one known optical property in the visible and/or invisible light domain(s) similar to the at least one predetermined optical property, the available data of reference optical articles resulting from said first and second experimental correlations.

Specifically, the method according to this preferred embodiment may comprise:
calculating a compensation coefficient from a reference value of the optical parameter and a measured value of the optical parameter for the at least one ink, the reference value of the optical parameter being derived from the available data of reference optical articles and corresponding to said at least one predicted optical property of the customized optical article, and then
obtaining a compensated inking level of the at least one ink from the calculated compensation coefficient.

As explained above, the optical parameter of the at least one ink which is used is preferably the above-defined K/S ratio thereof, and the at least one predetermined optical property of the customized optical article is more preferably its maximum absorbance value.

It will be noted that this compensation of the inking level(s) on the printed support to be reprinted with the newly compensated inking level(s) thus allows to simply and accurately obtain the at least one predetermined optical property of the optical article, by taking into account both first and second experimental correlations thanks to said available data of reference optical articles.

It will also be noted that said available data of reference optical articles together with the calculations of the compensation coefficient and of the resulting compensated inking level(s) may advantageously be provided by a computer program, configured to control the inking level of the at least one ink, for obtaining said customized optical article.

More preferably according to said preferred embodiment of the invention, the method comprises:
a) Printing by at least one printer the support according to a determined inking level for the at least one ink, the support being opaque to visible light and for example being made of paper or cardboard;
b) Measuring by reflection spectrophotometry, on the printed support, a reflectance parameter R of the at least one ink;
c) Converting the reflectance parameter R of the at least one ink into said measured value of the optical parameter of the at least one ink, by using a relationship between the reflectance parameter R and said optical parameter;
d) Comparing said measured value of the optical parameter of the at least one ink obtained in c) to said reference value of the optical parameter of the at least one ink, and determining the difference between both values;
e) If the difference determined in d) is not nil, calculating a compensation coefficient equal to the ratio of the reference value of the optical parameter to the measured value of the optical parameter for the at least one ink, and then obtaining the compensated inking level for the at least one ink by a rule of three from the calculated compensation coefficient;
f) Reprinting the support according to the compensated inking level for the at least one ink obtained in e);
g) Optionally sequentially repeating steps b) to f), with at least one newly compensated inking level for the at least one ink until the newly measured value of the optical parameter of the at least one ink is equal to the reference value of the optical parameter; and
h) thermally transferring by sublimation the at least one dye of the at least one ink printed at the currently or newly compensated inking level onto the optical article to be customized, and an optional fixing step depending of the constitutive material of the optical article on which the dye(s) was/were sublimated, consisting in fixing the sublimated dye onto the optical article, for example by an imbibition step for example carried out by air convection during sufficient time and with sufficient temperature to irreversibly fix the dye on the optical article, the time and temperature depending of the material of said optical article (for example between 100-160° C. and during one hour for an optical article made of Ormix®), or according to another example, an imbibition step carried out by surface irradiation, such as an IR/UV laser irradiation, to obtain the main surface of the customized optical article having said at least one predicted optical property which matches the at least one predetermined optical property.

Preferably, step c) is implemented by using, by way of the optical parameter, the K/S ratio of absorbance coefficient K to scattering coefficient S of the at least one printed ink, as defined by the Kubelka-Munk relationship: K/S=(1−R∞)²/2R∞.

It will be noted that steps d) and g) may alternatively be implemented by taking into account given tolerance intervals (i.e. each measured value being substantially equal to the corresponding reference value within this tolerance interval), when comparing:
in step d) the currently or newly measured value of the optical parameter to the reference value thereof, and
in step g) the currently or newly measured value of the optical parameter of the at least one ink to the reference value of the optical parameter.

According to another general feature of the invention which may relate to any of the preceding features and embodiments, the method may further comprise:
sequentially printing a plurality of times the support to detect inking variations over time due to said at least one printer for a given recipe for the at least one ink and to compensate for the detected inking variations, by adapting the inking level of the at least one ink for example by increasing said inking level in response to a previously detected decrease thereof, to provide consistent values for the at least one measured value of the optical parameter of the at least one ink and for the resulting at least one predetermined optical property of the customized optical article.

As explained above, the at least one predetermined optical property in the visible and/or invisible light domain(s) is preferably a maximum absorbance value of the optical article, measured at at least one given wavelength of the visible and/or invisible light domain(s).

According to another general feature of the invention which may relate to any of the preceding features and embodiments, the method may further comprise bringing a new printer in line with a reference printer by using a correction coefficient, the correction coefficient resulting from:
(i) reflectance parameter R measurements for said at least one ink printed on the support by the reference printer and by the new printer with the same printing parameters,
the reflectance parameter R measurements being converted into measured values of the optical parameter of the at least one ink, such as said K/S ratio, to obtain a calculated equivalent inking level for said at least one ink and to determine for said at least one ink an inking level ratio equal to the equivalent inking level calculated for the new printer/the equivalent inking level calculated for the reference printer,
the inking level ratio representing the correction coefficient to be applied to the printing parameters of the new printer, so as to bring the new printer in line with the reference printer; or from
(ii) visual transmittance Tv measurements on the customized optical articles,
said at least one ink being printed on the support by the reference printer and by the new printer with the same printing parameters, and the sublimation being carried out to obtain the customized optical articles for said at least one ink printed by both printers,
the transmittance Tv measurements being transformed into absorptance A measurements, and a resulting ratio for said at least one ink being calculated, the absorptance ratio being equal to the absorptance deduced from the transmittance measured with the new printer/the absorptance deduced from the transmittance measured with the reference printer,
a straight line being obtained corresponding to the absorptance of said at least one ink at its characteristic wavelength versus the inking level, and in case the two straight lines respectively obtained for both printers have a different slope, then a slope ratio is calculated which is equal to the slope obtained by the new printer/the slope obtained by the reference printer, which slope ratio determines the correction coefficient to be applied to said at least one ink printed by the new printer.

According to another general feature of the invention which may relate to any of the preceding features and embodiments, the method may further comprise a monitoring of the inking level of said at least one ink printed on the support by said at least one printer, according to a set print parameter defining a set inking level, the monitoring comprising reflectance parameter R measurements for said at least one ink,
the reflectance parameter R measurements being converted into measured values of the optical parameter of the at least one ink, such as said K/S ratio, to obtain a calculated equivalent inking level for said at least one ink,
an inking level ratio defining a correction factor being calculated, which is equal to the equivalent inking level for said at least one ink/the set inking level, and in case the correction factor is outside a predetermined range for said at least one ink, such as less than 0.9 or greater than 1.1, then at least a second printing of said at least one ink is carried out in the same manner and the corresponding correction factor is again determined for said at least one ink, and
if the correction factor for said at least one ink after the at least one second printing is still outside said range, then an ink cartridge of said at least one printer is replaced.

According to a first example of the invention, the at least one predetermined optical property is in the visible light domain, the at least one ink comprising at least one primary color consisting of cyan and/or magenta and/or yellow (CMY, i.e. a subtractive color model), and the primary color(s) being separately printed on the support (i.e. not mixed together thereon), and then the inking level of each primary color being separately controlled.

According to a second example of the invention which may optionally be combined to the first example above, the at least one predetermined optical property is in the invisible light domain, and the at least one ink comprises an invisible single-component dye selected from UV absorbers, IR absorbers and blue light absorbers for optical articles, e.g. for ophthalmic lenses.

According to another general feature of the invention which may relate to any of the preceding features, embodiments and examples, the thermal transfer may comprise:
(i) drying the printed support,
(ii) transferring by sublimation, by vacuum heating, the at least one ink from the dried printed support onto a surface of an optical blank intended to form said customized optical article, and
(iii) fixing the at least one dye into a superficial sublayer, e.g. of several μm thick, of the optical blank, to form said main surface of the customized optical article.

The present invention is also directed to a system for obtaining a customized optical article comprising a main surface having at least one predetermined optical property in visible and/or invisible light domain(s) selected from absorbance and transmittance, by a thermal transfer via a sublimation technique from a printed support comprising a support and at least one ink printed on the support according to an inking level, the at least one ink comprising at least one sublimable dye selected from visible dyes, invisible dyes and mixtures thereof.

According to the invention, the system comprises at least one printer and a computer readable medium equipping or coupled to the least one printer, the computer readable medium carrying one or more stored sequence of instructions of a computer program which is accessible to a processor and which, when executed by the processor, causes the processor to control the inking level of the at least one ink, for obtaining said customized optical article by using an experimentally determined variation law of the at least one predetermined optical property as a function of the inking level of the at least one ink.

According to other features of the invention, the system may further comprise a reflection spectrophotometer configured to measure, on the printed support, a reflectance parameter R of the at least one ink, and
the one or more stored sequence of instructions may be configured to implement said variation law of the at least one predetermined optical property as a function of the inking level of the at least one ink, said variation law being experimentally determined by using in combination:
   a first experimental correlation between an optical parameter of the at least one ink on the printed support and the inking level thereof, the optical parameter being calculated from said reflectance parameter R of the at least one ink and being selected from its K/S ratio of absorbance coefficient to scattering coefficient, its optical density, its colorimetric coefficients such as its colorimetric lightness L* and colorimetric coefficients a* and b*, and combinations thereof, and
   a second experimental correlation between at least one predicted optical property of the customized optical article, selected from maximum absorbance and minimum transmittance values of the optical article and measured at at least one given wavelength of visible or invisible light domains, and said optical parameter of the at least one ink.

According to still other features of the system of the invention:
the first experimental correlation may be a linear one of the type y=a x+b, where y denotes the optical parameter of the at least one ink on the printed support, x denotes the inking level of the at least one ink, and a, b are constants, and
the second experimental correlation may be a linear one of the type y=a′ x+b′, where y denotes the at least one predicted optical property of the customized optical article, x denotes the optical parameter of the at least one ink on the printed support, and a′, b′ are constants.

According to still other features of the system of the invention:
the one or more stored sequence of instructions may be configured to compensate the inking level for the at least one ink, by means of said first experimental correlation and available data of reference optical articles which were beforehand manufactured by said thermal transfer from a similar printed support, the available optical articles each comprising a main surface having at least one known optical property in visible and/or invisible light domain(s) similar to the at least one predetermined optical property, the available data of reference optical articles resulting from said first and second experimental correlations, and
the one or more stored sequence of instructions may be configured to:
   calculate a compensation coefficient from a reference value of the optical parameter and a measured value of the optical parameter for the at least one ink, the reference value of the optical parameter being derived from the available data of reference optical articles and corresponding to said at least one predicted optical property of the customized optical article, and then
   to obtain a compensated inking level of the at least one ink from the calculated compensation coefficient.

### DESCRIPTION OF DRAWINGS

FIG. 1 shows an exemplary recipe of the three separate primary colors cyan (C), magenta (M) and yellow (Y) which are printed and separately analyzed by reflection spectrophotometry in the method of the invention;

FIGS. 2a-2c are three graphs, in a first series of experiments according to the invention relating to visible inks, showing the evolution of paper reflectance as a function of the wavelength (nm) of a paper printed with the three separate primary colors each at an inking level of 50% (i.e. 2000 dots per inch: dpi), respectively in FIGS. 2a, 2b, 2c for M, Y, C colors;

FIGS. 3a-3c are three graphs, according to a first embodiment of the first series of experiments, showing the evolution of the K/S ratio as a function of the inking level (dpi) for the three separately printed primary colors, respectively in FIGS. 3a, 3b, 3c for M measured at 520 nm, Y at 410 nm and C at 650 nm;

FIGS. 4a-4c are three graphs, according to this first embodiment of the first series of experiments, showing the evolution of the maximum absorbance of a Ormix® lens as a function of the K/S ratio of the printed paper for the three separate primary colors, respectively in FIGS. 4a, 4b, 4c for M measured at 520 nm, Y at 410 nm and C at 650 nm;

FIGS. 5a-5c are three graphs, in another embodiment of the first series of experiments, showing the evolution of the optical density as a function of the inking level (expressed in abscissa as a coefficient in % of the 2000 dpi inking level) for the three separately printed primary colors, respectively in FIGS. 5a, 5b, 5c for M, Y, C;

FIGS. 6a-6c are three graphs, in still another embodiment of the first series of experiments, showing the evolution of the colorimetric lightness L* as a function of the inking level (expressed as a coefficient of 2000 dpi for C and M, and of 1200 dpi for Y in %) for the three separately printed primary colors, respectively in FIGS. 6a, 6b, 6c for C, M, Y;

FIGS. 7a-7c are three graphs, in still another embodiment of the first series of experiments, showing the evolution of the colorimetric coefficient a* as a function of the inking level (expressed as a coefficient of 2000 dpi in %) for the three separately printed primary colors, respectively in FIGS. 7a, 7b, 7c for C, M, Y;

FIGS. 8a-8c are three graphs, in still another embodiment of the first series of experiments, showing the evolution of the colorimetric coefficient b* as a function of the inking level (expressed as a coefficient of 2000 dpi in %) for the three separately printed primary colors, respectively in FIGS. 8a, 8b, 8c for C, M, Y;

FIGS. 9a-9c are three graphs, according to said first embodiment of the first series of experiments, showing the evolution overtime of the K/S ratio of the printed paper for the three separate primary colors, respectively in FIGS. 9a, 9b, 9c for M, Y, C;

FIG. 10 is a graph, in a second series of experiments according to the invention relating to seven recipes comprising magenta and cyan primary colors at constant inking levels and an invisible ink consisting of a UV absorber at variable inking levels, showing the evolution of the paper reflectance as a function of the wavelength (nm);

FIG. 11 is a graph, according to a first embodiment of this second series of experiments, showing the evolution of the K/S ratio measured at 410 nm, as a function of the inking level in dpi of the UV absorber defining the recipes, the vertical bars representing the minimum and maximum values obtained from measurements done on ten printed papers;

FIG. 12 is a graph, according to the first embodiment of this second series of experiments, showing the evolution of the light transmission at 415 nm through the ORMA® lens as a function of the K/S ratio measured at 410 nm for the seven recipes, on the left side of the printed papers, the vertical bars representing the minimum and maximum values obtained from measurements done on ten printed papers;

FIG. 13 is a graph, according to the first embodiment of this second series of experiments, showing the evolution of the light absorbance at 415 nm through the ORMA® lens obtained by means of the K/S ratio as a function of the inking level in dpi of the UV absorber defining the recipes;

FIG. 14 is a graph, according to this second series of experiments as an embodiment comparative to that of FIG. 11, showing the evolution of the optical density measured at 410 nm as a function of the inking level in dpi of the UV absorber defining the recipes;

FIG. 15 is a graph, according to this second series of experiments as another embodiment comparative to that of FIG. 11, showing the evolution of the paper reflectance measured at 410 nm as a function of the inking level in dpi of the UV absorber defining the seven printed recipes;

FIG. 16 is a graph, according to the first embodiment of FIG. 11 of this second series of experiments, showing the evolution over time (in terms of days) of the K/S ratio for the seven printed recipes and the corresponding tolerances for the values of the K/S ratio;

FIG. 17 is a graph of an absorptance spectrum vs wavelength for M, Y, C according to another embodiment of the invention using a correction coefficient to bring two printers in line with each other, starting from visual transmittance measurements of lenses obtained by both printers;

FIG. 18a is a graph relating to the embodiment of FIG. 17, showing for each printer the linear evolution of absorptance as a function of the inking level (dpi) for Y on each printed paper, with the absorptance values resulting from said visual transmittance measurements;

FIG. 18b is a graph relating to the embodiment of FIG. 17, showing for each printer the linear evolution of absorptance as a function of the inking level (dpi) for M on each printed paper, with the absorptance values resulting from said visual transmittance measurements;

FIG. 18c is a graph relating to the embodiment of FIG. 17, showing for each printer the linear evolution of absorptance as a function of the inking level (dpi) for C on each printed paper, with the absorptance values resulting from said visual transmittance measurements;

FIG. 19a is a graph relating to the embodiment of FIGS. 17 and 18b, showing the linear evolution of a corrected absorptance of the obtained lenses vs the inking level (dpi) for a M primer, by using a correction coefficient for absorptances between both printers;

FIG. 19b is a graph relating to the embodiment of FIGS. 17 and 18a, showing the linear evolution of a corrected absorptance of the obtained lenses vs the inking level (dpi) for a Y primer, by using a correction coefficient for absorptances between both printers;

FIG. 19c is a graph relating to the embodiment of FIGS. 17 and 18c, showing the linear evolution of the corrected absorptance of the obtained lenses vs the inking level (dpi) for a C primer, by using a correction coefficient for absorptances between both printers;

FIG. 20a is a screenshot showing optical parameter measurements including reflectance for a paper printed with the M primary color, according to still another embodiment of the invention distinct from those of FIGS. 18-19c, which relates to the monitoring of the inking level of a printer for the M color amongst M, Y, C, by using a correction factor for M;

FIG. 20b is a screenshot showing optical parameter measurements including reflectance for a paper printed with the Y primary color, according to the same embodiment of FIG. 20a but relating to the monitoring of the inking level of the printer for the Y color, by using a correction factor for Y; and

FIG. 20c is a screenshot showing optical parameter measurements including reflectance for a paper printed with the C primary color, according to the embodiment of FIGS. 20a and 20b but relating to the monitoring of the inking level of the printer for the C color, by using a correction factor for C.

### DETAILED DESCRIPTION OF THE INVENTION

In the present description, the terms “comprise” (and any grammatical variation thereof, such as “comprises” and “comprising”), “have” (and any grammatical variation thereof, such as “has” and “having”), “contain” (and any grammatical variation thereof, such as “contains” and “containing”), and “include” (and any grammatical variation thereof, such as “includes” and “including”) are open-ended linking verbs. They are used to specify the presence of stated features, integers, steps or components or groups thereof, but do not preclude the presence or addition of one or more other features, integers, steps or components or groups thereof. As a result, a method, or a step in a method, that “comprises,” “has,” “contains,” or “includes” one or more steps or elements possesses those one or more steps or elements, but is not limited to possessing only those one or more steps or elements.

Unless otherwise indicated, all numbers or expressions referring to quantities of ingredients, ranges, reaction conditions, etc. used herein are to be understood as modified in all instances by the term “about.” Also unless otherwise indicated, the indication of an interval of values «from X to Y» or “between X to Y”, according to the present invention, means as including the values of X and Y.

Visible and/or Invisible Light Domain(s), Visible and/or Invisible Dyes

“Visible light domains” include light domains that are visible to the human eye i.e. light domains whose wavelengths are inside the visible domain range of 380 to about 750 nm. Such light domains include for example emission range of LED-based digital devices, between 380 and 500 nm, preferably between 430 and 470 nm, most preferably between 440 and 460 nm), and blue-violet radiation from 400 to 455 nm, which corresponds to the harmful part of blue radiation as defined in ISO TR20772:2018 and in several peer-reviewed papers (Marie et al., Cell Death and Disease, 2020), (Marie et al., Cell Death and Disease, 2018), (Arnault, Barrau et al., 2013).

“Visible dyes” concern dyes absorbing light in the so called visible light domain.

“Invisible light domains” include light domains that are not visible to the human eye, i.e. light domains whose wavelengths are outside the visible domain range of 380 to about 750 nm. These invisible light domains include ultraviolet (UV) domain, Near Infrared (NIR), Infrared (IR) domain.

“Invisible dyes” concern dyes absorbing light in the so called invisible light domain.

### Optical Articles

An optical article according to the invention comprises at least one ophthalmic lens or optical filter or optical glass or optical material suitable for human vision, or optical film or patch intended to be fixed on a substrate, or a specific layer of a multilayer optical film, e.g. at least one ophthalmic lens, or optical film or patch intended to be fixed on a substrate, or optical glass, or optical material intended for use in an ophthalmic instrument, for example for determining the visual acuity and/or the refraction of a subject, or any kind of safety device including a safety glass or safety wall intended to face an individual's eye, such as a protective device, for instance safety lenses or a mask or shield.

The optical article may be implemented as eyewear equipment having a frame that surrounds at least partially one or more ophthalmic lenses. By way of non-limiting example, the optical article may be a pair of glasses, sunglasses, safety goggles, sports goggles, a contact lens, an intraocular implant, an active lens with an amplitude modulation such as a polarized lens, or with a phase modulation such as an auto-focus lens, etc.

The at least one ophthalmic lens or optical glass or optical material suitable for human vision or optical film or patch intended to be fixed on a substrate can provide an optical function to the user, i.e. the wearer of the lens.

It can for instance be a corrective lens, namely, a power lens of the spherical, cylindrical and/or addition type for an ametropic user, for treating myopia, hypermetropia, astigmatism and/or presbyopia. The lens can have a constant power, so that it provides power as a single vision lens would do, or it can be a progressive lens having variable power.

The optical article of the invention may consist of any known mineral and/or organic optical material(s) comprising for example a mineral (i.e. made of mineral glass) or organic (i.e. polymeric) ophthalmic substrate in the particular case of an ophthalmic lens part to be obtained, the ophthalmic substrate being made of a thermoplastic or thermoset material.

### Example of Ophthalmic Lenses

Among thermoplastics suitable for ophthalmic substrates, mention may be made of (meth)acrylic (co)polymers, in particular polymethyl methacrylate (PMMA), thio(meth)acrylic (co)polymers, polyvinylbutyral (PVB), polycarbonates (PCs, including homopolycarbonates, copolycarbonates and sequenced copolycarbonates), polyesters such as polyethylene terephthalate (PET) or polybutylene terephthalate (PBT), polycarbonate/polyester copolymers, cyclo-olefin copolymers such as ethylene/norbornene copolymers or ethylene/cyclopentadiene copolymers and combinations thereof, and thermoplastic ethylene/vinyl acetate copolymers.

Among thermosets suitable for ophthalmic substrates, mention may be made of polyurethanes (PUs), polythiourethanes, polyol(allyl carbonate) (co)polymers, polyepisulfides, and polyepoxides. Other usable thermosets are (co)polymers of the acrylic type the refractive index of which is comprised between 1.5 and 1.65 and typically close to 1.6. These acrylic (co)polymers are obtained by polymerization of (meth)acrylic monomer blends and optionally allyl and/or vinyl aromatic monomers. The (meth)acrylate (i.e. acrylate or methacrylate) monomers may be monofunctional or multifunctional, typically bearing from 2 to 6 (meth)acrylate groups. These monomers may be aliphatic, cyclic, aromatic, polyalkoxylated, derivatives of compounds such as bisphenol and/or bear other functions such as epoxy, thioepoxy, hydroxyl, thiol, sulfide, carbonate, urethane and/or isocyanate functions.

Exemplary thermosets for ophthalmic substrates include:
cycloolefin copolymers such as ethylene/norbornene or ethylene/cyclopentadiene copolymers,
homopolymers and copolymers of allyl carbonates of linear or branched aliphatic or aromatic polyols, such as homopolymers of diethylene glycol bis(allyl carbonate),
homopolymers and copolymers of (meth)acrylic acid and esters thereof, which are optionally derived from bisphenol A,
homopolymers and copolymers of thio(meth)acrylic acid and esters thereof,
homopolymers and copolymers of allyl esters which are optionally derived from bisphenol A or phthalic acids, and allyl aromatics such as styrene,
copolymers of urethane and thiourethane,
homopolymers and copolymers of epoxy, and
homopolymers and copolymers of sulfide, disulfide and episulfide.

The ophthalmic substrates may be obtained by polymerization of blends of the above monomers, or may even comprise blends of these polymers and (co)polymers.

Particularly recommended organic ophthalmic substrates are substrates:
obtained by (co)polymerization of diethylene glycol bis(allyl carbonate), i.e. a homopolymer or copolymer of an allyl carbonate of a linear or branched aliphatic or aromatic polyol, even more preferably an homopolymer of diethylene glycol bis(allyl carbonate) sold, for example, under the trademark CR-39® by the company PPG Industries, the resulting substrate being sold under the trademark ORMA® lenses,
made of polythiourethane copolymers, such as the so-called “MR-7”, “MR-8” (the resulting substrate being sold under the trademark ORMIX® lenses), “MGC N19”, MR-10 or “MR-1.74” lens substrates, sold, for example, by the company Mitsui, or
thermoplastic substrates of polycarbonate type.

In certain applications, it is preferable for the front main face of the ophthalmic substrate to be coated with one or more functional coatings prior to the deposition of an optional multilayer inorganic coating. These functional coatings, which are conventionally used in optics, may be, non-limitingly, an anti-shock primer layer, an anti-abrasion and/or anti-scratch coating, a polarizing coating, a photochromic coating or a colored coating. Generally, this front main face of the substrate is thus coated with an anti-shock primer layer, an anti-abrasion coating and/or an anti-scratch coating, or an anti-shock primer layer coated with an anti-abrasion and/or anti-scratch coating.

The multilayer inorganic coating may be deposited on an anti-abrasion and/or anti-scratch coating, which may be any layer conventionally used as an anti-abrasion and/or anti-scratch coating in the field of ophthalmic lenses. These abrasion- and/or scratch-resistant coatings are preferably hard coatings based on poly(meth)acrylates or silanes generally comprising one or more mineral fillers intended to increase the hardness and/or the refractive index of the coating once cured, and they are preferably produced from compositions comprising at least one alkoxysilane and/or one hydrolysate thereof, for example obtained by hydrolysis with a hydrochloric acid solution and optionally condensation and/or curing catalysts. Mention may be made of coatings based on hydrolysates of epoxysilanes such as those described in documents FR 2702486 (EP 0614957), U.S. Pat. Nos. 4,211,823 and 5,015,523.

One preferred composition for anti-abrasion and/or anti-scratch coatings is that disclosed in document FR 2702486 in the name of the Applicant. It comprises a hydrolysate of epoxy trialkoxysilane and dialkyl dialcoxysilane, colloidal silica and a catalytic amount of an aluminum-based curing catalyst such as aluminum acetylacetonate, the rest essentially consisting of solvents conventionally used for the formulation of such compositions.

The anti-abrasion and/or anti-scratch coating composition may be deposited on the main face of the substrate by dip coating or spin coating. It is then cured using the appropriate process (preferably thermally, or under UV). The thickness of the anti-abrasion and/or anti-scratch coating generally varies from 2 μm to 10 μm, and preferably from 3 μm to 5 μm.

Prior to the deposition of the anti-abrasion and/or anti-scratch coating, it is possible to deposit, on the substrate, a primer coating (also called a tie layer) that improves the resistance to shocks and/or the adhesion of subsequent layers in the final product. This coating may be any anti-shock primer layer conventionally used for articles made of transparent polymer.

Among preferred primer compositions, mention may be made of compositions based on thermoplastic polyurethanes, such as those described in documents JP 63-141001 and JP 63-87223, poly(meth)acrylic primer compositions, such as those described in document U.S. Pat. No. 5,015,523, compositions based on thermoset polyurethanes, such as those described in document EP 0404111 and compositions based on poly(meth)acrylic latex or polyurethane latex, such as those described in documents U.S. Pat. No. 5,316,791 and EP 0680492. Preferred primer compositions are compositions based on polyurethanes and compositions based on latex, in particular polyurethane latexes optionally containing polyester units.

It is also possible to use in the primer compositions blends of these latexes, in particular polyurethane latex and poly(meth)acrylic latex.

Before the multilayer inorganic coating is deposited on the substrate optionally coated for example with an anti-abrasion layer, it is possible to subject the surface of said optionally coated substrate to a chemical or physical activation treatment intended to increase the adhesion of the coating. This pre-treatment is generally carried out under vacuum. It may be a question of a bombardment with energetic species, for example an ion beam (ion precleaning or IPC), of a corona-discharge treatment, of an electron beam, of a UV treatment, or of a treatment by plasma under vacuum, generally an argon or oxygen plasma. It may also be a question of an acid or basic surface treatment and/or of a surface treatment with solvents (water or organic solvent).

The various layers of the multilayer inorganic coating and the optional underlayer are preferably deposited by vacuum deposition using one of the following techniques:
(i) evaporation, optionally assisted by ion beam,
(ii) ion-beam sputtering,
(iii) cathode sputtering, or
(iv) plasma-enhanced chemical vapor deposition.

These various techniques are described in the works “Thin Film Processes” and “Thin Film Processes II” Vossen & Kern, Ed., Academic Press, 1978 and 1991, respectively. One particularly recommended technique is the technique of vacuum evaporation.

Preferably, the deposition of each of the layers of said coating and the optional underlayer is carried out by vacuum evaporation.

The ophthalmic lens may be made antistatic, i.e. not retain and/or develop an appreciable electrostatic charge, by virtue of the incorporation of at least one electrically conductive layer in said multilayer inorganic coating. This electrically conductive layer is preferably located between two layers of said inorganic coating, and/or is adjacent to a high-refractive-index layer of this coating. Preferably, this electrically conductive layer is located immediately under a said low-refractive-index layer and ideally forms the penultimate layer of said coating, it being located immediately under the most external (low-index, e.g. silica-based) layer of said coating.

The electrically conductive layer must be sufficiently thin to not alter the transparency of said coating, and it is preferably manufactured from a highly transparent electrical conductor. In this case, its thickness varies preferably from 1 nm to 15 nm, and better still from 1 nm to 10 nm. This conductive layer preferably comprises an optionally doped metal oxide, chosen from oxides of indium, of tin, of zinc and mixtures thereof. Indium-tin oxide (In2O3:Sn for tin-doped indium oxide), aluminum-doped zinc oxide (ZnO:Al), indium oxide (In2O3) and tin oxide (SnO2) are preferred. Even more preferably, this optically transparent conductive layer is a layer of indium-tin oxide (ITO) or a layer of tin oxide.

The ophthalmic lens may also comprise complementary functionalities such as, non-limitingly:
coatings formed on the external (i.e. exposed) surface of said multilayer inorganic coating and capable of modifying its surface properties, such as for example an anti-fouling or anti-fog top coat (external coating);
specific filtration functionalities such as for example filtration of the UV, of the blue-violet (400 nm-460 nm) or IR, within a coating or directly integrated into the substrate; and/or
a polarizing function.

By way of anti-fouling coatings, which may typically be hydrophobic and/or oleophobic and which have a thickness in general smaller than or equal to 10 nm, preferably of 1 nm to 10 nm, and better still of 1 nm to 5 nm, mention may be made of coatings of fluorosilane or fluorosilazane type which may be obtained by depositing a fluorosilane or fluorosilazane precursor, preferably comprising at least two hydrolysable groups per molecule. The precursor fluorosilanes preferably contain fluoropolyether groups and better still perfluoropolyether groups. These fluorosilanes are well known and are described, inter alia, in documents U.S. Pat. Nos. 5,081,192, 5,763,061, 6,183,872, 5,739,639, 5,922,787, 6,337,235, 6,277,485 and EP 0933377. One preferred hydrophobic and/or oleophobic coating composition is sold by Shin-Etsu Chemical under the trade name KP 801 M®. Another preferred hydrophobic and/or oleophobic coating composition is sold by Daikin Industries under the trade name OPTOOL DSX®. It is a fluororesin comprising perfluoropropylene groups.

Thus, an ophthalmic lens may for example comprise a substrate coated in succession on its front main face with an anti-shock primer layer, an anti-abrasion and/or anti-scratch layer, a multilayer inorganic coating and a hydrophobic and/or oleophobic top coat.

As for the rear main face of the substrate, it may for example be coated, in succession, with an anti-shock primer layer, an anti-adhesion and/or anti-scratch layer, an antireflection coating preferably with a low reflectance in the domain of the UV and a hydrophobic and/or oleophobic coating.

As explained above, the ophthalmic lenses susceptible to be obtained by the method of the invention are tinted by visible dyes derived from the C, M, Y primary colors, and/or are provided with at least one invisible light absorber such as IR, UV and/or blue light absorbers.

### Measurement of Optical Parameters of Printed Supports and of Optical Properties of Optical Articles

The optical parameters of the at least one ink on the printed support may be:
its K/S ratio of absorbance coefficient to scattering coefficient, as defined by the Kubelka-Munk relationship K/S=(1−R∞)²/2R∞, where R∞ denotes the reflectance parameter R of the at least one ink measured by reflection spectrophotometry (derived from the diffuse reflectance of an infinitely thick layer on the printed support);
its optical density OD, as knowingly defined by: OD=log₁₀ R where R is the minimum of Reflectance measured; and/or
its colorimetric coefficients, such as its colorimetric lightness L* and colorimetric coefficients a* and b*, which refer to reflected light on front face in the international colorimetric system CIE L*a*b* and are calculated between 380 and 780 nm, taking the standard illuminant D 65 and the observer into account (angle of 10°). The observer is a “standard observer” as defined in the international colorimetric system CIE L*a*b*.

As for the optical articles, the optical properties may in particular be:

Rv (%)—visual reflectance (average luminous reflectance factor in the visible domain calculated using the equation given in ISO 13666:1998 standard and measured according to ISO 8980-4 standard, which is the weighted average of the spectral reflectance over all of the visible spectrum between 380 nm and 780 nm). As for the spectral reflectance, it is defined in as being the ratio of the spectral radiant flux reflected by the material to the incident spectral flux at any specified wavelength.

Rm (%)—mean reflectance (mean value of the spectral reflectance over a wavelength range of 400 nm to 700 nm).

Tv (%)—visual transmittance (luminous transmittance in the visible domain calculated using the equation given in ISO 13666:1998 standard, which means the average relative light transmission factor in the 380-780 nm wavelength range, weighted according to the sensitivity of the eye at each wavelength of the range and measured under D65 illumination conditions).

Absorbance: fraction of the incident radiation which is neither reflected nor transmitted, according to ISO 13666:1998. In particular for a lens, absorption is characterized by the ratio αᵢ=ϕₐ/ϕᵢₙ, where ϕα is the radiant flux absorbed between the entrance and exit surfaces of the lens, represented by ϕᵢₙ−ϕₑₓ, and ϕᵢₙ is the radiant flux that has successfully passed through the lens. If lens absorption varies with wavelength, the lens' internal spectral absorption factor αi_{λ} is determined in the same way for each wavelength A of incident light.

### EXAMPLES OF METHODS IMPLEMENTED ACCORDING TO THE INVENTION

1. First Series of Experiments (See FIGS. 1-9c) for Obtaining, by Sublimation and Imbibition, Customized Ophthalmic Lenses Having a Predetermined Maximum Absorbance in Visible Domain and Tinted with the C, M, and/or Y Primary Colors

### 1.1. First Preferred Embodiment (See FIGS. 1-4c)

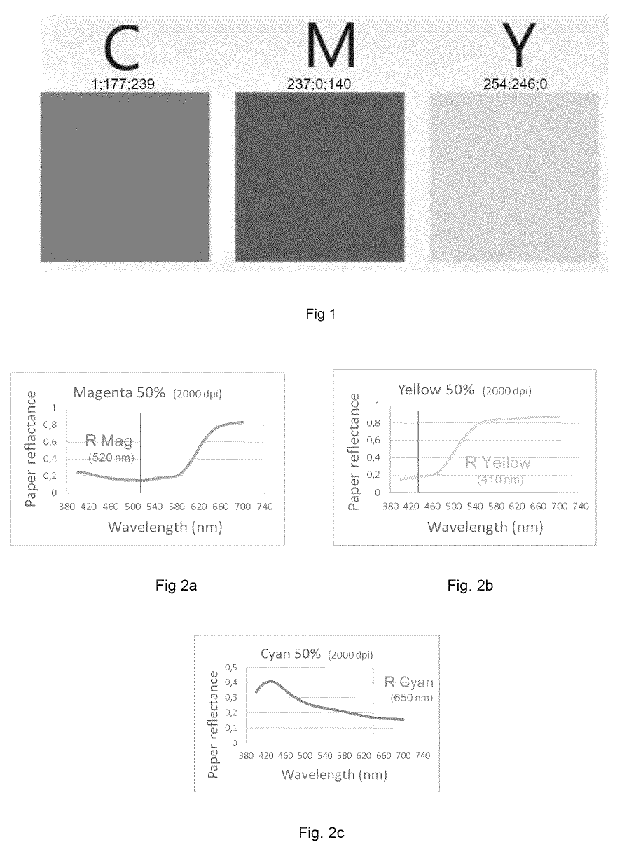

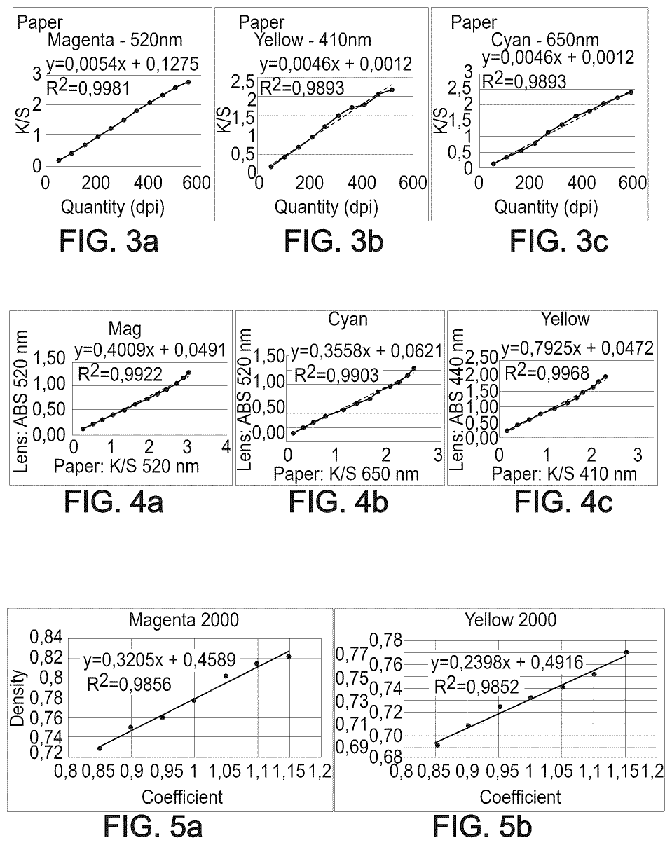

According to the first embodiment of this first series of experiments, where said optical parameter for the C, M, Y inks on the printed support used for said first and second experimental correlations was selected to be the K/S ratio, the method was implemented by carrying out the following successive steps:
a) Printing, by a commercially available inkjet printer, a paper according to a determined inking level of 50% (i.e. half of the maximum inking quantity, e.g. 2000 dpi) for each primary color C, M, Y (the primary colors are printed separately, see FIG. 1);
b) Separately measuring by reflection spectrophotometry, on the printed paper, the reflectance parameter R of each printed primary color C, M, Y (as a function of the wavelength, see the three graphs of FIGS. 2a-2c);
c) For each separately printed primary color C, M, Y, converting the measured reflectance parameter R into a value of the K/S ratio, by using the relationship between R and K/S (K/S=(1−R)²/2R) by selecting wavelengths of 520 nm for magenta, 410 nm for yellow and 650 nm for cyan from the graphs of FIGS. 2a-2c, for the calculation of each K/S ratio;
d) For each separately printed primary color C, M, Y, comparing this measured value of the K/S ratio obtained in c) to a reference value of K/S from data of reference lenses manufactured from the same paper by identical sublimation step and having a similar maximum absorbance, these data being available from a software storage medium coupled to the printer and resulting from said first and second experimental correlations (as explained below with reference to FIGS. 3a-3c and 4a-4c, respectively), and determining the difference between both measured and reference values;
e) For each separately printed primary color C, M, Y, if the difference determined in d) is not nil, calculating a compensation coefficient “CC” equal to the ratio of the reference value of K/S to the measured value K/S [i.e. CC=(K/S)_{reference}/(K/S)_{measured}], and then obtaining the compensated inking level “CIL” by a rule of three from the calculated compensation coefficient [e.g. CIL=CC×2000 dpi, for a 50% current inking level of each primary color C, M, Y];
f) Reprinting the paper according to the compensated inking level for each separate primary color C, M, Y obtained in e);
g) Optionally sequentially repeating steps b) to f), with at least one newly compensated inking level for each separate primary color C, M, Y until the newly measured value of the K/S ratio of each separate primary color C, M, Y is equal to the reference value of K/S ratio; and
h) thermally transferring by sublimation each primary color C, M, Y printed at the currently or newly compensated inking level onto the ophthalmic lenses to be customized which thus exhibits the desired predetermined maximum absorbance.

Regarding step d) and as visible in FIGS. 3a-3c, the inventors have established that, according to the present invention, there is indeed a proportionality relationship between the K/S ratio of each separately printed primary color C, M, Y and its inking level, as witnessed by:
FIG. 3a for M at 520 nm which shows that said first experimental correlation approximates a linear one of the type y=0.0054 x−0.1275 (with R²=0.9981), where y denotes the K/S ratio of M and x denotes the inking level of M in dpi;
FIG. 3b for Y at 410 nm which shows that said first experimental correlation approximates a linear one of the type y=0.0046 x−0.0012 (with R²=0.9893), where y denotes the K/S ratio of Y and x denotes the inking level of Y in dpi;
FIG. 3c for C at 650 nm which shows that said first experimental correlation approximates a linear one of the type y=0.0047 x−0.1046 (with R²=0.9935), where y denotes the K/S ratio of Y and x denotes the inking level of C in dpi.

As visible in FIGS. 4a-4c, the inventors have also established that there is a proportionality relationship between the maximum absorbance of an Ormix® lens and the K/S ratio obtained for each separately printed primary color C, M, Y, as witnessed by:
FIG. 4a for M which shows that said second experimental correlation approximates a linear one of the type y=0.4009 x+0.0491 (with R²=0.9922), where y denotes the maximum absorbance of M and x denotes the K/S ratio measured for M at 520 nm;
FIG. 4b for Y which shows that said second experimental correlation approximates a linear one of the type y=0.7925 x+0.0472 (with R²=0.9868), where y denotes the maximum absorbance of Y and x denotes the K/S ratio measured for Y at 410 nm;
FIG. 4c for C which shows that said second experimental correlation approximates a linear one of the type y=0.3558 x−0.0621 (with R²=0.9903), where y denotes the K/S ratio of C and x denotes the inking level of C at 650 nm.

As a consequence, the inventors have established that the color of the lens, determined by its maximum absorbance, is directly linked to the inking level of the or each primary color C, M, Y on the printed paper, which inking level may be controlled by the K/S ratio to predict the maximum absorbance of the lens by means of a compensation coefficient which is applied to the current inking level of each primary color C, M, Y.

Specifically, the compensation coefficient is calculated from a reference value of the K/S ratio and a measured value of the K/S ratio for each of C, M, Y, and then as result of a simple rule of three, there is obtained a compensated inking level for each primary color C, M, Y. The reference value of the K/S value was chosen according to the first day when printing the paper with C, M, Y begun.

Tables 1 and 2 below detail an exemplary implementation of the method of the invention according to this first preferred embodiment of the first series of experiments.

TABLE 1

| Measurement of | | |
|---|---|---|
| reflectance R | Conversion into | Calculation of |
| for C, M, Y | K/S ratio | compensation coefficient |
| for M (520 nm): | K/S measured for M: | CC for M: |
| R = 0.1491 | K/S = (1-0.1491)²/2 · | CC = (K/S)_{reference}/ |
| | 0.1491 | (K/S)_{measured} |
| | K/S = 2.428 | CC = 2.350/2.428 = 0.97 |
| for Y (410 nm): | K/S measured for Y: | CC for Y: |
| R = 0.1747 | K/S = (1-0.1747)²/2 · | CC = (K/S)_{reference}/ |
| | 0.1747 | (K/S)_{measured} |
| | K/S = 1.949 | CC = 1.920/1.949 = 0.98 |
| for C (650 nm): | K/S measured for C: | CC for C: |
| R = 0.1693 | K/S = (1-0.1693)²/2 · | CC = (K/S)_{reference}/ |
| | 0.1693 | (K/S)_{measured} |
| | K/S = 2.038 | CC = 1.918/2.038 = 0.94 |

From the compensation coefficients calculated for each of C, M, Y as initially printed, the reflectance R for C, M, Y was measured again from a compensated inking level OIL derived from each compensation coefficient CC by a rule of three (OIL=CC×2000 dpi, for a 50% initial current inking level), then converted as explained above into a new K/S ratio and as a result into a new compensation coefficient, until the predicted maximum absorbance resulting from the newly measured K/S ratio matches the predetermined maximum absorbance to be obtained for the customized lens, by matching (i.e. being equal to) the reference K/S ratio.

TABLE 2

| Measurement of new | | |
|---|---|---|
| reflectance R for | Conversion into a new | Calculation of a new |
| C, M, Y | K/S ratio | compensation coefficient |
| for M (520 nm): | K/S measured for M: | CC for M: |
| As CC = 0.97, | K/S = (1-0.15205)²/2 · | CC = (K/S)_{reference}/ |
| CIL = 0.97 × 50% | 0.15205 | (K/S)_{measured} |
| ⇒ R = 0.15205 | K/S = 2.364 | CC = 2.350/2.364 = 0.99 |
| for Y (410 nm): | K/S measured for Y: | CC for Y: |
| As CC = 0.98, | K/S = (1-0.1768)²/2 · | CC = (K/S)_{reference}/ |
| CIL = 0.98 × 50% | 0.1768 | (K/S)_{measured} |
| ⇒ R = 0.1768 | K/S = 1.916 | CC = 1.920/1.916 = 1.00 |
| for C (650 nm): | K/S measured for C: | CC for C: |
| As CC = 0.94, | K/S = (1-0.17829)²/2 · | CC = (K/S)_{reference}/ |
| CIL = 0.94 × 50% | 0.17829 | (K/S)_{measured} |
| ⇒ R = 0.17829 | K/S = 1.894 | CC = 1.918/1.894 = 1.01 |

Once the newly calculated compensation coefficient is equal (or nearly equal according to a given tolerance) to 1.00, which means that the newly measured K/S ratio matches the reference K/S ratio and hence the predetermined maximum absorbance to be obtained for the lens, the printed paper including the or each primary color C, M, Y was thermally transferred in step h) above, by sublimation and then fixing the sublimated dyes for example by imbibition onto the lens blank, so that the ophthalmic lens exhibiting the desired maximum absorbance was finally obtained, thanks to an appropriate fixation of the primary color(s) into a superficial sublayer (of several μm thick) of the lens blank.

As visible in the graphs of FIGS. 9a-9c showing the evolution over days of the K/S ratio of the printed paper for the primary colors M, Y, C including the minimum and maximum tolerances for the K/S ratio values, a daily adjustment (i.e. control) of the inking level of the commercially available inkjet printer was additionally required, to keep a substantially constant inking level or each primary color over days and, as a result, reproducible primary colors for the obtained ophthalmic lenses. Specifically, as soon as a significant decrease of the inking level was detected for a primary color, the printer was adjusted so that it printed this primary color according to a correspondingly increased inking level.

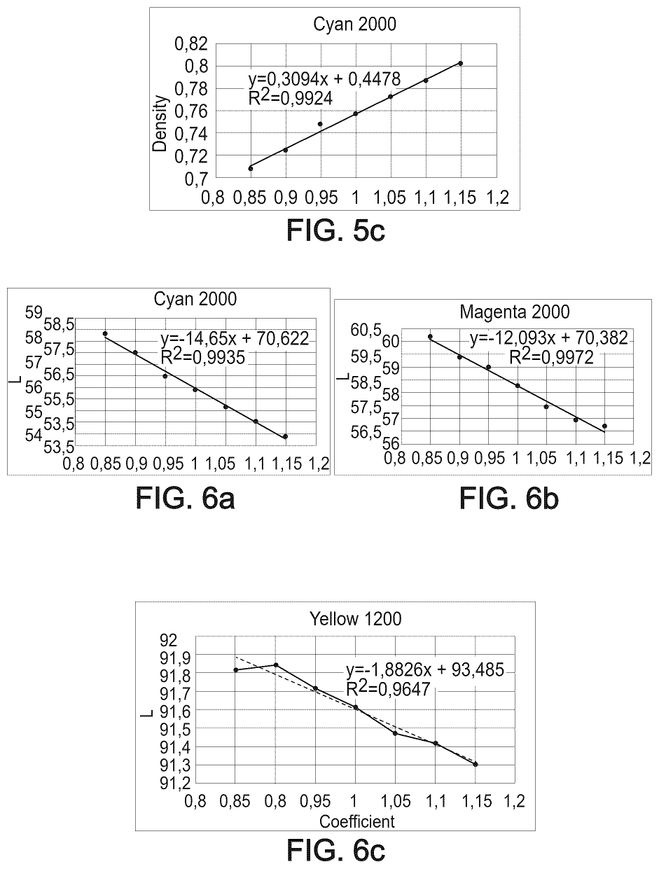

### 1.2. Other Embodiments of the First Series of Experiments (See FIGS. 5a-8c)

1.2.1. According to the other embodiment of FIGS. 5a-5c, where said optical parameter for the M, Y, C inks on the printed paper used for said first and second experimental correlations was selected to be the optical density, the method was implemented by carrying out the same successive steps a) to h) presented in § 1.1 above, except that steps c) to g) were carried out by using the proportionality established by the inventors between the optical density of each separately printed primary colors M, Y, C and their respective inking levels on the printed paper, and between the maximum absorbance of an Ormix® lens and the optical density obtained for each printed primary color M, Y, C.

Specifically, as visible in FIGS. 5a-5c obtained after printing a paper by a commercially available inkjet printer with M, Y, C, the inventors established that said first experimental correlation approximates a linear one of the type y=a x+b, where y denotes the optical density of M, Y, C and x denotes the coefficient in % of the 2000 dpi inking level of M, Y, C in FIGS. 5a, 5b, 5c, respectively.

1.2.2. According to the other embodiment of FIGS. 6a-6c, where said optical parameter for the C, M, Y inks on the printed paper used for said first and second experimental correlations was selected to be the colorimetric lightness L*, the method was implemented by carrying out the same successive steps a) to h) presented in § 1.1 above, except that steps c) to g) were carried out by using the proportionality established by the inventors between the colorimetric lightness L* of each separately printed primary colors C, M, Y and their respective inking levels on the printed paper, and between the maximum absorbance of an Ormix® lens and the colorimetric lightness L* obtained for each printed primary color C, M, Y.

Specifically, as visible in FIGS. 6a-6c obtained after printing a paper by a commercially available inkjet printer with C, M, Y, the inventors established that said first experimental correlation approximates a linear one of the type y=a x+b, where y denotes the colorimetric lightness L* of C, M, Y and x denotes the coefficient in % of the 2000 dpi inking level of C, M, and of 1200 dpi inking level of Y in FIGS. 6a, 6b, 6c, respectively.

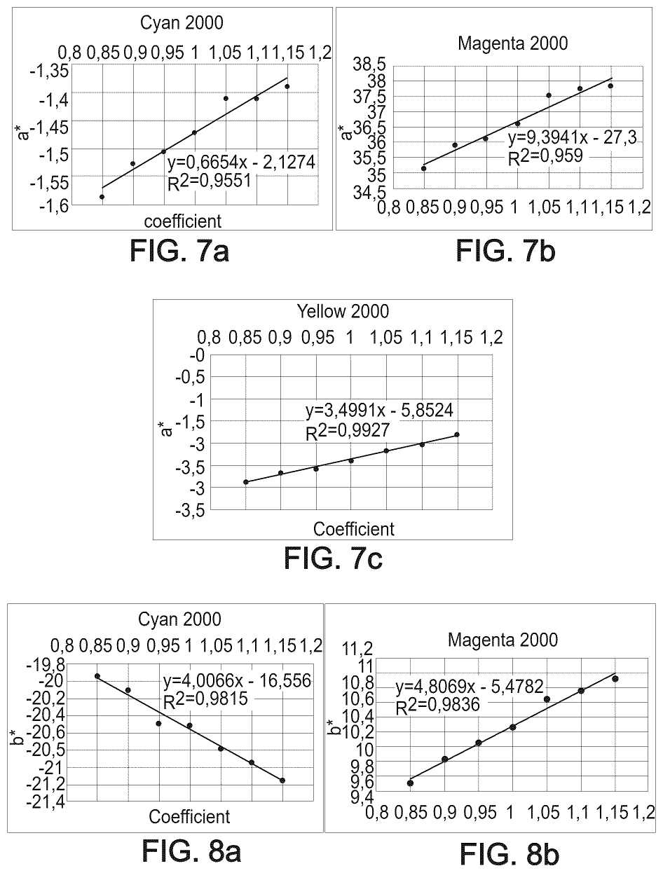

1.2.3. According to the other embodiment of FIGS. 7a-7c, where said optical parameter for the C, M, Y inks on the printed paper used for said first and second experimental correlations was selected to be the colorimetric coefficient a*, the method was implemented by carrying out the same successive steps a) to h) presented in § 1.1 above, except that steps c) to g) were carried out by using the proportionality established by the inventors between the colorimetric coefficient a* of each separately printed primary colors C, M, Y and their respective inking levels on the printed paper, and between the maximum absorbance of an Ormix® lens and the colorimetric coefficient a* obtained for each printed primary color C, M, Y.

Specifically, as visible in FIGS. 7a-7c obtained after printing a paper by a commercially available inkjet printer with C, M, Y, the inventors established that said first experimental correlation approximates a linear one of the type y=a x+b, where y denotes the colorimetric coefficient a* of C, M, Y and x denotes the coefficient in % of the 2000 dpi inking level of C, M, Y in FIGS. 7a, 7b, 7c, respectively.

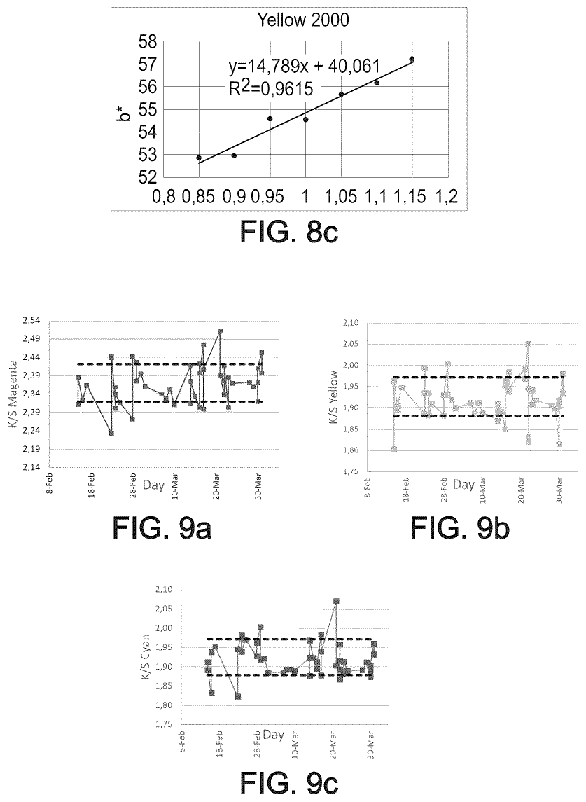

1.2.4. According to the other embodiment of FIGS. 8a-8c, where said optical parameter for the C, M, Y inks on the printed paper used for said first and second experimental correlations was selected to be the colorimetric coefficient b*, the method was implemented by carrying out the same successive steps a) to h) presented in § 1.1 above, except that steps c) to g) were carried out by using the proportionality established by the inventors between the colorimetric coefficient b* of each separately printed primary colors C, M, Y and their respective inking levels on the printed paper, and between the maximum absorbance of an Ormix® lens and the colorimetric coefficient b* obtained for each printed primary color C, M, Y.

Specifically, as visible in FIGS. 8a-8c obtained after printing a paper by a commercially available inkjet printer with C, M, Y, the inventors established that said first experimental correlation approximates a linear one of the type y=a x+b, where y denotes the colorimetric coefficient b* of C, M, Y and x denotes the coefficient in % of the 2000 dpi inking level of C, M, Y in FIGS. 8a, 8b, 8c, respectively.

Generally speaking, it is to be noted that any kind of commercially available sublimable C, M, Y inks useful in the ophthalmic field, may be usable in the present invention.

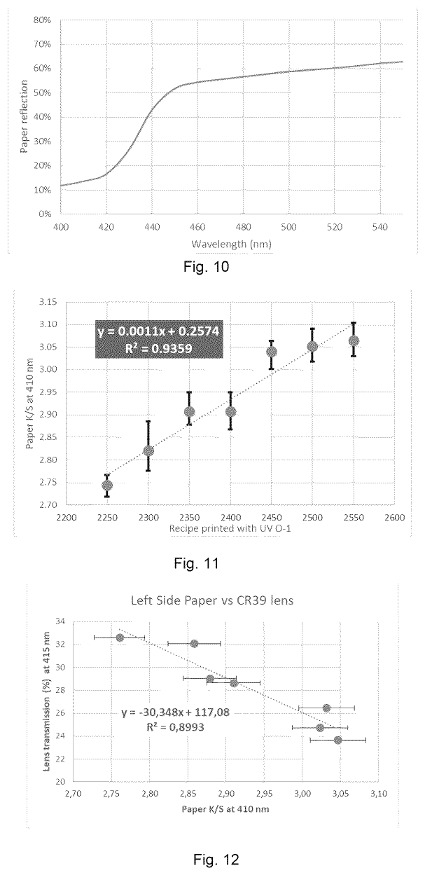

2. Second Series of Experiments (See FIGS. 10-15) for Obtaining, by Sublimation and Imbibition, Customized Ophthalmic Lenses Having Predetermined Transmission and/or Maximum Absorbance in Both Visible Domain (M and C Primary Colors) and Invisible Domain (UV Absorber)

Seven recipes 1-7, each comprising magenta (M) and cyan (C) at given inking levels (with no yellow Y primary color) and a sublimable commercially available UV absorber useful in the field of ophthalmic, were separately printed by the same commercially available inkjet printer, as detailed in table 3 below.

TABLE 3

| | M primary | Y primary | | C primary |
|---|---|---|---|---|
| Recipe | color | color | UV absorber | color |
| 1 | 25 | 0 | 2250 | 58 |
| 2 | 25 | 0 | 2300 | 58 |
| 3 | 25 | 0 | 2350 | 58 |
| 4 | 25 | 0 | 2400 | 58 |
| 5 | 25 | 0 | 2450 | 58 |
| 6 | 25 | 0 | 2500 | 58 |
| 7 | 25 | 0 | 2550 | 58 |

### 2.1. First Preferred Embodiment (See FIGS. 10-12 and 15)

According to the first embodiment of this second series of experiments, where said optical parameter for the UV invisible ink on the printed support used for said first and second experimental correlations was selected to be the K/S ratio, the method was implemented by carrying out the following successive steps:
a) Printing, by the commercially available inkjet printer, a paper according to the predetermined inking levels of the UV for the separately printed recipes;
b) Separately measuring by reflection spectrophotometry, on the printed paper, the reflectance parameter R of each printed recipe (as a function of the wavelength, see the graph of FIG. 10);
c) For each separately printed recipe, converting the measured reflectance parameter R into a value of the K/S ratio, by using the relationship between R and K/S (K/S=(1−R)²/2R) by selecting the wavelength of 410 nm in FIG. 10 for calculating each K/S ratio;
d) For each separately printed recipe, comparing this measured value of the K/S ratio obtained in c) to a reference value of K/S from data of reference lenses manufactured from the same paper by identical sublimation and dye fixing steps and having a similar minimum transmittance or maximum absorbance, these data being available from a software storage medium coupled to the printer and resulting from said first and second experimental correlations (as explained below with reference to FIGS. 11-13, respectively), and determining the difference between both measured and reference values;
e) For each separately printed recipe, if the difference determined in d) is not nil, calculating a compensation coefficient “CC” equal to the ratio of the reference value of K/S to the measured value K/S [i.e. CC=(K/S)_{reference}/(K/S)_{measured}], and then obtaining the compensated inking level “CIL” by a rule of three from the calculated compensation coefficient [e.g. CIL=CC×2250 dpi, for a current inking level of 2250 dpi for the recipe 1];
f) Reprinting the paper according to the compensated inking level for each separate recipe obtained in e);
g) Optionally sequentially repeating steps b) to f), with at least one newly compensated inking level for the or each separate recipe until the newly measured value of the K/S ratio of each separate recipe is equal to the reference value of K/S ratio; and
h) thermally transferring by sublimation the dye of each recipe printed at the currently or newly compensated inking level onto the ophthalmic lenses to be customized which thus exhibits the desired predetermined maximum absorbance or minimum transmittance.

Regarding step d), the inventors have established that, according to the present invention, there is indeed a proportionality relationship between the K/S ratio of each separately printed recipe and the inking levels of the UV absorber in the printed recipes, as witnessed by FIG. 11 in which said first experimental correlation approximates a linear one of the type y=0.0011 x−0.2574 (with R²=0.9359), where y denotes the K/S ratio of M and x denotes the inking level of the UV absorber ranging from 2250 to 2550 dpi.

The inventors have also established that there is a proportionality relationship between the lens transmittance at 415 nm of an ORMA® lens and the K/S ratio obtained at 410 nm for each separately printed recipe (i.e. for each inking level of the UV absorber), as witnessed by FIG. 12 which shows that said second experimental correlation approximates a linear one of the type y=−30.348 x+117.08 (with R²=0.8993), where y denotes the transmittance and x denotes the K/S ratio.

It is to be noted that in FIGS. 11 and 12, the black bars (vertical in FIG. 11, horizontal in FIG. 12) represent the minimum and maximum values that were obtained for the K/S ratio, among five measurements which were carried out on the printed paper.

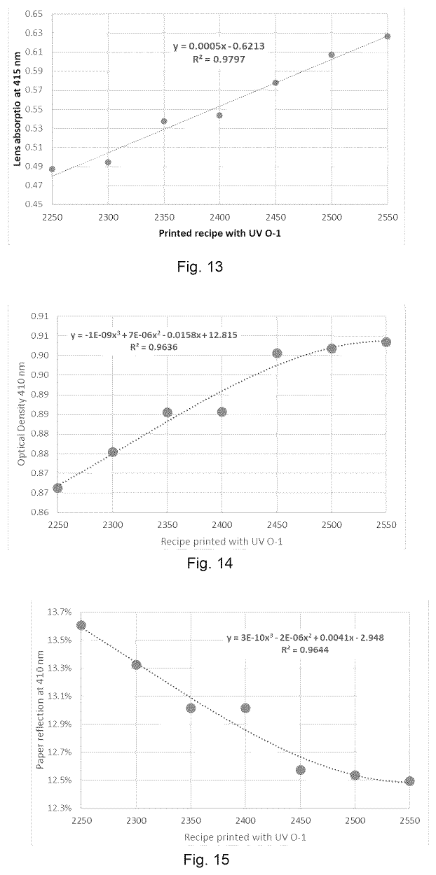

Further, the inventors have established that there is a proportionality relationship between the maximum absorbance of an ORMA® lens and the inking levels of the UV absorber defining the printed recipes, as witnessed by FIG. 13 which shows that said second experimental correlation approximates a linear one of the type y=0.0005 x−0.6213 (with R²=0.9797), where y denotes the maximum absorbance and x denotes the inking levels of the UV absorber; In other words, the inventors have established that the absorptive/transmissive power of the lens is directly linked to the inking level of the UV absorber on the printed paper, which inking level is controlled by the K/S ratio to predict the maximum absorbance or minimum transmittance of the lens by means of a compensation coefficient which is applied to the current inking level of the or each recipe.

Specifically, the compensation coefficient is calculated from a reference value of the K/S ratio and a measured value of the K/S ratio for the UV absorber, and then as result of a simple rule of three, there is obtained a compensated inking level for the UV absorber. The reference value of the K/S value was chosen according to the first day when printing the paper with the recipes begun.

Tables 4 and 5 below detail an exemplary implementation of the method of the invention according to this first preferred embodiment of the second series of experiments.

TABLE 4

| Measurement of | | |
|---|---|---|
| reflectance R for | Conversion into | Calculation of |
| the UV absorber | K/S ratio | compensation coefficient |
| For UV absorber | K/S measured for UV | CC for UV absorber: |
| at 410 nm | absorber: | CC = (K/S)_{reference}/ |
| R = 0.1301 | K/S = (1-0.1301)²/2 · | (K/S)_{measured} |
| | 0.1301 | CC = 2.966/2.908 = 1.020 |
| | K/S = 2.908 | |

From the compensation coefficients calculated for the UV absorber as initially printed in each recipe, the reflectance R was measured again from a compensated inking level CIL derived from each compensation coefficient CC by a rule of three, then converted as explained above into a new K/S ratio and as a result into a new compensation coefficient, until the predicted maximum absorbance or minimum transmittance resulting from the newly measured K/S ratio matches the predetermined maximum absorbance or minimum transmittance to be obtained for the customized lens, by matching (i.e. being equal to) the reference K/S ratio.

TABLE 5

| Measurement of new | Conversion into a new | Calculation of a new |
|---|---|---|
| reflectance R | K/S ratio | compensation coefficient |
| for UV absorber: | K/S measured for UV | CC for UV absorber: |
| As CC = 1.020, | absorber: | CC = (K/S)_{reference}/ |
| ⇒ R = 0.1283 | K/S = (1-0.1283)²/2 · | (K/S)_{measured} |
| | 0.1283 | CC = 2.966/2.961 = |
| | K/S = 2.961 | 1.002 |

Once the newly calculated compensation coefficient is equal (or nearly equal according to a given tolerance) to 1.00, which means that the newly measured K/S ratio matches the reference K/S ratio and hence the predetermined maximum absorbance or minimum transmittance to be obtained for the customized lens, the printed paper including the UV absorber was thermally transferred in step h) above, by sublimation and then fixing step such as imbibition onto the lens blank, so that the ophthalmic lens exhibiting the desired maximum absorbance or minimum transmittance was finally obtained, thanks to an appropriate fixation of the UV absorber into a superficial sublayer (of several μm thick) of the lens blank.

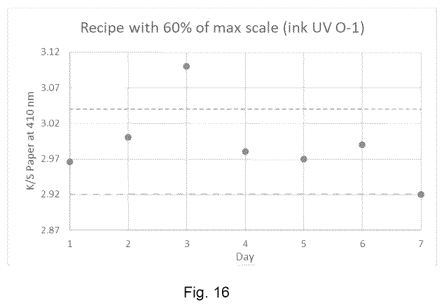

As visible in the graph of FIG. 16 showing the evolution over days of the K/S ratio at 410 nm of the printed paper for the UV absorber (at 60% of the maximum inking level, including the minimum and maximum tolerances for the K/S ratio values), a daily adjustment of the inking level of the commercially available inkjet printer was additionally required, to keep a substantially constant inking level of the UV absorber over days and, as a result, reproducible absorbance or transmittance for the obtained ophthalmic lenses. Specifically, as soon as a significant decrease of the inking level was detected for the UV absorber, the printer was adjusted so that it printed this UV absorber according to a correspondingly increased inking level.

Generally speaking, it is to be noted that any kind of commercially available sublimable UV absorbers useful in the ophthalmic field may be usable in the present invention.

### 2.2. Other Embodiments of the Second Series of Experiments (See FIGS. 14-15)

2.2.1. According to the comparative embodiment of FIG. 14, where said optical parameter for the UV absorber on the printed paper used for said first and second experimental correlations was selected to be the optical density thereof, the method of the invention gave quite satisfactory results at low and medium inking levels of the UV absorber (between about 2250 and 2450 dpi) where a proportionality relationship was observed between the optical density and the inking level of the UV absorber, but not at higher inking levels of the UV absorber (above about 2450 dpi), where a cubic function—hence not a linear one—was approximated.

2.2.2. According to the other comparative embodiment of FIG. 15, where said optical parameter for the UV absorber on the printed paper used for said first and second experimental correlations was selected to be the paper reflectance, the method of the invention also gave quite satisfactory results at low and medium inking levels of the UV absorber (between about 2250 and 2400 dpi) where a proportionality relationship was observed between the paper reflectance and the inking level of the UV absorber, but not at higher inking levels of the UV absorber (above about 2400 dpi), where another cubic function—hence not a linear one—was approximated.

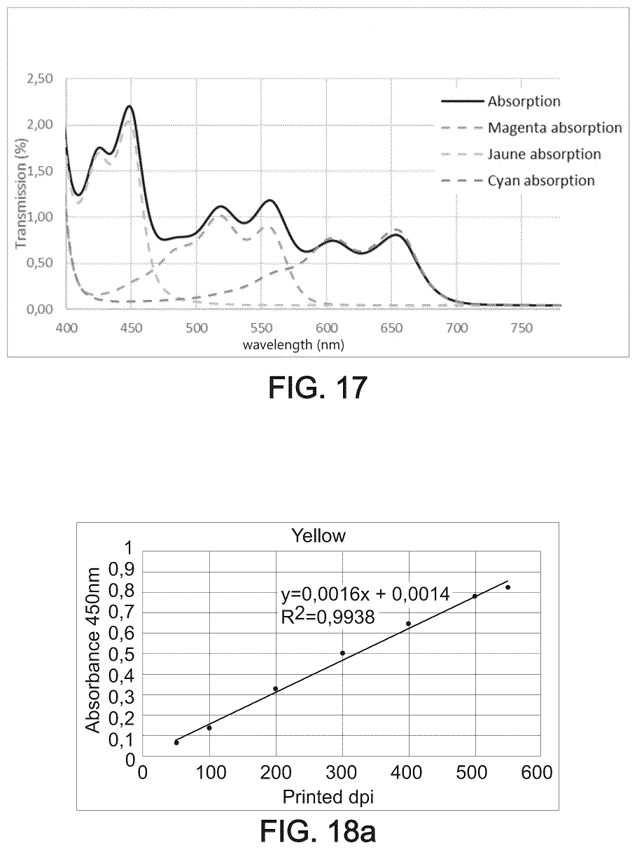

3. Experiments (See FIGS. 17-19c) for Obtaining Customized Ophthalmic Lenses Tinted with the C, M and/or Y Primary Colors, by Using a Correction Coefficient to Bring a New Printer in Line with a Reference Printer
3.1. Experiments which Used Reflectance Parameter R Measurements on the Printed Papers

The three primary colors M, Y, C were printed by each of the reference printer and the new printer, with the same printing parameters (for example 2000 dpi).

Reflectance measurements were realized for each obtained color M, Y, C thus printed on a paper by each printer.

Thanks to the above detailed conversion ratio K/S, an equivalent of calculated dpi (for example 1994 dpi for M printed by the reference printer, vs 2015 dpi for M printed by the new printer) was obtained for each color M, Y C and for each printer.

A dpi ratio was then determined for each color M, Y, C, this ratio being equal to the dpi calculated for each of M, Y, C for the new printer/the dpi calculated for the reference printer.

This ratio represented the correction to be brought to the printing parameters of the new printer, so as to bring this new printer in line with the reference printer.

3.2 Experiments (See FIGS. 17-19c) which Used Visual Transmittance Tv Measurements on Obtained Ophthalmic Lenses

The three primary colors M, Y, C were printed by each of the reference printer and the new printer, with the same printing parameters (for example 2000 dpi).

The sublimation and imbibition process was carried out on six identical ophthalmic lenses, for the three colors M, Y, C printed by both printers.

Then, the transmittance spectrum obtained on each of these six lenses was measured by a spectrophotometer “Cary 60”.

As visible in FIG. 17, for each color M, Y, C resulting from each printer, the lens transmittance Tv measurement was transformed into an absorptance A measurement (by using the well-known relationship A=2−log Tv), which allowed to have a better definition/discrimination (i.e. finely distinguishing) of each color, because they appeared in the form of an absorptance peak which was satisfactorily distinctive for each color and centered on a specific wavelength, whereas the transmittance spectrum of each color was less distinctive (i.e. it had a kind of broad crenellation, not a peak, see the absorptance spectrum in FIG. 17).

The absorptance ratio for each color M, Y, C was calculated, this ratio being equal to the absorptance deduced from the transmittance measured with the new printer/the absorptance deduced from the transmittance measured with the reference printer.

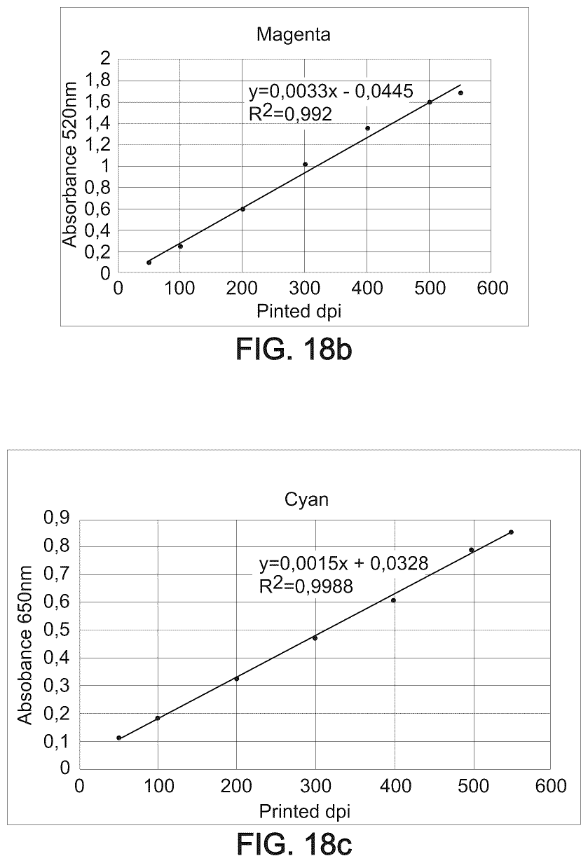

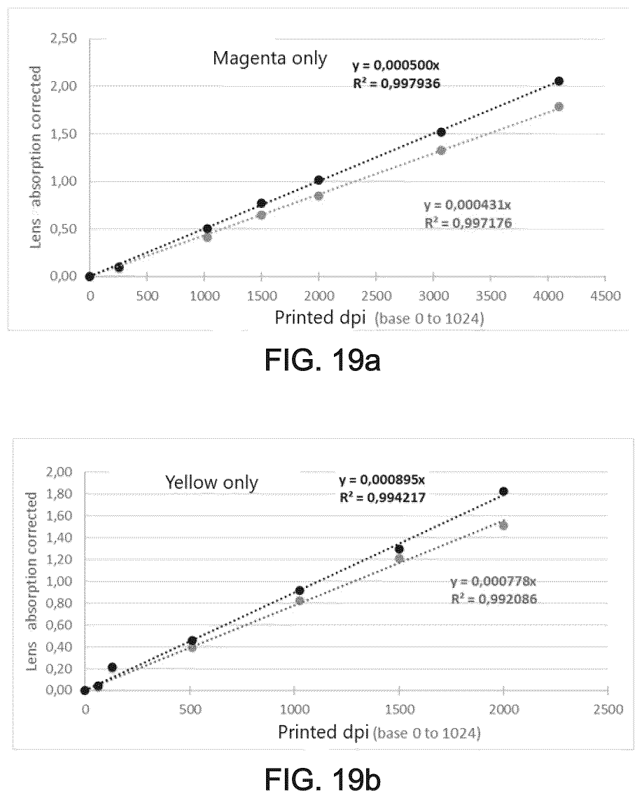

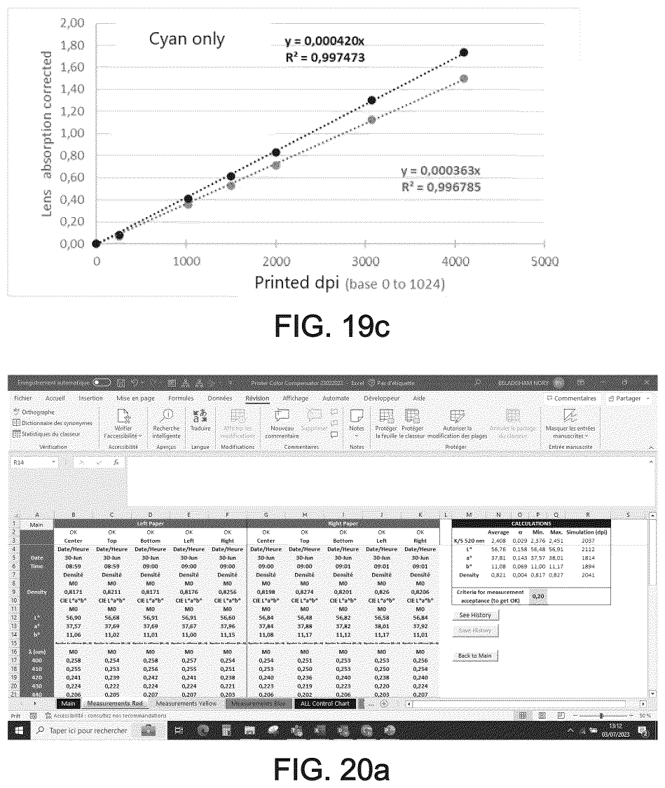

As visible in FIGS. 18a-18c and 19a-19c, the obtained straight line corresponding to each color absorptance for M, Y, C at its characteristic wavelength vs the dpi (i.e. color concentration) was traced. See in particular the graphs of corrected lens absorptance vs dpi in FIGS. 19a-19c for M, Y and C separate primers, respectively.

In case the two straight lines respectively obtained for both printers had a different slope, then a slope ratio was calculated which was equal to the slope obtained by the new printer/the slope obtained by the reference printer, which slope ratio determined a correction coefficient that was applied to each color M, Y, C obtained by the new printer (for example, the new printer could deliver more ink than the reference printer). In an example, the slope ratio of new printer/reference printer was of about 0.85.

Table 6 below gives exemplary correction coefficients which were obtained for the slope ratio of new printer/reference printer for the three colors M, Y, C.

TABLE 6

| Printers | Magenta (M) | Yellow (Y) | Cyan (C) |
|---|---|---|---|
| Commercially | 0.000500 | 0.000895 | 0.000420 |
| available inkjet printer | | | |
| Commercially | 0.000431 | 0.000778 | 0.000363 |
| available inkjetprinter | | | |
| Correction | 0.86 | 0.87 | 0.86 |
| coefficient | | | |

It may be noted that both methods disclosed in the above § 3.1 and § 3.2 appeared to be reliable and to lead to similar results (i.e. leading to substantially identical correction coefficients), even though the method of § 3. 2 using visual transmittance Tv measurements on ophthalmic lenses is preferred, in order to take into account all possible unforeseen/negative effects resulting from the whole process (from the initial printing step to the sublimation and imbibition steps).

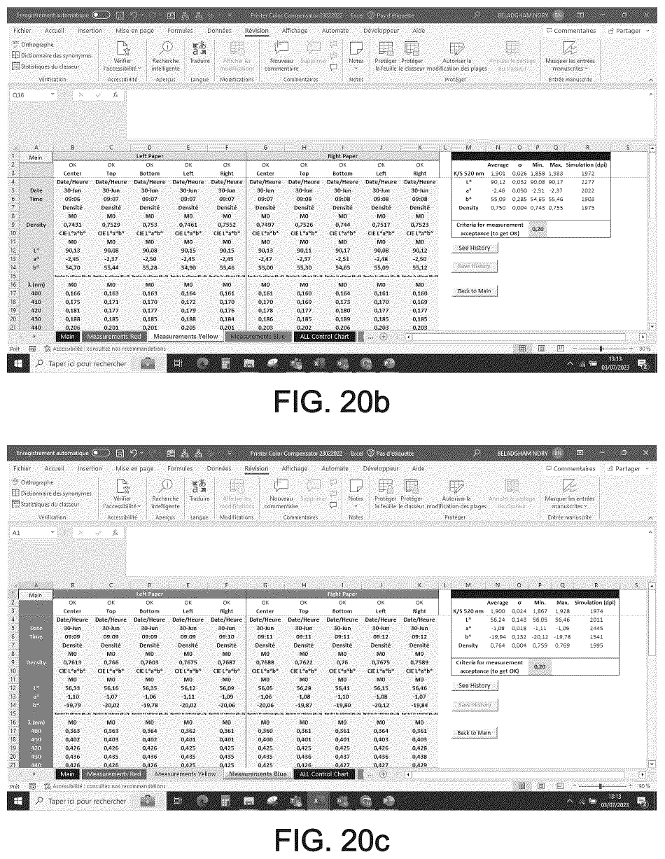

4. Experiments (See FIGS. 20a-20c) for Monitoring the Inking Level of a Printer (Instead of a Simple Traditional Visual Monitoring of an Ink Refill)

The three primary colors M, Y, C were printed by the printer with the same printing parameters (for example 2000 dpi).

The reflectance parameter R of each printed color obtained on the paper was measured, amongst other optical parameters.

Thanks to the above detailed conversion ratio K/S, a simulation (i.e. a calculated equivalent estimation) of dpi was obtained for each color M, Y, C (for example 1994 dpi for M, 2215 dpi for Y and 1800 dpi for C).

Specifically, compared to the 2000 dpi (set print parameter) which were measured for M, Y, C on a printed paper by an operator, table 7 below shows some exemplary simulated dpi that were obtained using the K/S conversion ratio, from the analyzed paper measurements.

TABLE 7
Simulated dpi obtained from K/S ratios

| | | | |
|---|---|---|---|
| Magenta (M) | 2037 | Difference | 1.86% |
| Yellow (Y) | 1972 | Difference | −1.39% |
| Cyan (C) | 1974 | Difference | −1.28% |

The ratio of the equivalent dpi for each color M, Y, C/the set print parameter (2000 dpi in the present example) was calculated. Table 8 below shows exemplary correction factors that were eventually obtained in this way.

TABLE 8
Correction factors obtained for the printer

| | Current factor | New factor |
|---|---|---|
| Magenta (M) | 1.00 | 1.00 |
| Yellow (Y) | 1.00 | 1.00 |
| Cyan (C) | 1.00 | 1.00 |

In case the correction factors denoted by the above-defined ratios were either less than 0.9 or greater than 1.1 (i.e. with more than a ±10% difference) for at least one of the three primary colors M, Y, C, then a second printing of the concerned color(s) was carried out and the corresponding correction factor(s) was (were) determined. If the concerned correction factor(s) after this second printing was (were) still outside the range of a ±10% difference, then the ink cartridge was determined to be replaced with another one.

It may be noted that this monitoring method according to the invention may advantageously be automated, and that an ink level alert requiring a cartridge replacement may be created for at least one of the primary colors M, Y, C.

1. A method for obtaining a customized optical article comprising a main surface having at least one predetermined optical property in visible and/or invisible light domain(s) selected from absorbance and transmittance, by a thermal transfer via a sublimation technique from a printed support comprising a support and at least one ink printed on the support according to an inking level, the at least one ink comprising at least one sublimable dye selected from visible dyes, invisible dyes and mixtures thereof,
wherein the method comprises controlling the inking level of the at least one ink to obtain said customized optical article, by using an experimentally determined variation law of the at least one predetermined optical property as a function of the inking level of the at least one ink.

2. The method of claim 1, wherein said variation law of the at least one predetermined optical property as a function of the inking level of the at least one ink is experimentally determined by using in combination:
a first experimental correlation between an optical parameter of the at least one ink on the printed support and the inking level thereof, the optical parameter of the at least one ink being selected from its K/S ratio of absorbance coefficient to scattering coefficient, its optical density, its colorimetric coefficients such as its colorimetric lightness L* and colorimetric coefficients a* and b*, and combinations thereof; and
a second experimental correlation between at least one predicted optical property of the customized optical article, selected from maximum absorbance and minimum transmittance values of the optical article and measured at at least one given wavelength of the visible and/or invisible light domain(s), and said optical parameter of the at least one ink.

3. The method of claim 2, wherein:
the first experimental correlation is a linear one of the type y=a x+b, where y denotes the optical parameter of the at least one ink on the printed support, x denotes the inking level of the at least one ink, and a, b are constants representative of the at least one ink; and
the second experimental correlation is a linear one of the type y=a′ x+b′, where y denotes the at least one predicted optical property of the customized optical article, x denotes the optical parameter of the at least one ink on the printed support, and a′, b′ are constants representative of the at least one ink.

4. The method of claim 2, wherein the method comprises compensating the inking level for the at least one ink, by means of said first experimental correlation and available data of reference optical articles which were beforehand manufactured by said thermal transfer from a similar printed support, the reference optical articles each comprising a main surface having at least one known optical property in the visible and/or invisible light domain(s) similar to the at least one predetermined optical property, the available data of reference optical articles resulting from said first and second experimental correlations, and wherein the method comprises:
calculating a compensation coefficient from a reference value of the optical parameter and a measured value of the optical parameter for the at least one ink, the reference value of the optical parameter being derived from the available data of reference optical articles and corresponding to said at least one predicted optical property of the customized optical article; and
obtaining a compensated inking level of the at least one ink from the calculated compensation coefficient.

5. The method of claim 4, wherein the method comprises:
a) printing by at least one printer the support according to a determined inking level for the at least one ink, the support being opaque to visible light and for example being made of paper;
b) measuring by reflection spectrophotometry, on the printed support, a reflectance parameter R of the at least one ink;
c) converting the reflectance parameter R of the at least one ink into said measured value of the optical parameter of the at least one ink, by using a relationship between the reflectance parameter R and said optical parameter;
d) comparing said measured value of the optical parameter of the at least one ink obtained in c) to said reference value of the optical parameter of the at least one ink and determining the difference between both values;
e) if the difference determined in d) is not nil, calculating a compensation coefficient equal to the ratio of the reference value of the optical parameter to the measured value of the optical parameter for the at least one ink, and then obtaining the compensated inking level for the at least one ink by a rule of three from the calculated compensation coefficient;
f) reprinting the support according to the compensated inking level for the at least one ink obtained in e);
g) optionally sequentially repeating steps b) to f), with at least one newly compensated inking level for the at least one ink until the newly measured value of the optical parameter of the at least one ink is equal to the reference value of the optical parameter; and
h) thermally transferring by sublimation the at least one dye of the at least one ink printed at the currently or newly compensated inking level onto the optical article to be customized, to obtain the main surface of the customized optical article having said at least one predicted optical property which matches the at least one predetermined optical property.

6. The method of claim 5, wherein the method further comprises sequentially printing a plurality of times the support to detect inking variations over time due to said at least one printer for a given recipe for the at least one ink and to compensate for the detected inking variations, by adapting the inking level of the at least one ink for example by increasing said inking level in response to a previously detected decrease thereof, to provide consistent values for the at least one measured value of the optical parameter of the at least one ink and for the resulting at least one predetermined optical property of the customized optical article.

7. The method of claim 5, wherein the method further comprises bringing a new printer in line with a reference printer by using a correction coefficient, the correction coefficient resulting from:
(i) reflectance parameter R measurements for said at least one ink printed on the support by the reference printer and by the new printer with the same printing parameters,
the reflectance parameter R measurements being converted into measured values of the optical parameter of the at least one ink, such as said K/S ratio, to obtain a calculated equivalent inking level for said at least one ink and to determine for said at least one ink an inking level ratio equal to the equivalent inking level calculated for the new printer/the equivalent inking level calculated for the reference printer,
the inking level ratio representing the correction coefficient to be applied to the printing parameters of the new printer, so as to bring the new printer in line with the reference printer; or from
(ii) visual transmittance Tv measurements on the customized optical articles,
said at least one ink being printed on the support by the reference printer and by the new printer with the same printing parameters, and the sublimation being carried out to obtain the customized optical articles for said at least one ink printed by both printers,
the transmittance Tv measurements being transformed into absorptance A measurements, and a resulting ratio for said at least one ink being calculated, the absorptance ratio being equal to the absorptance deduced from the transmittance measured with the new printer/the absorptance deduced from the transmittance measured with the reference printer,
a straight line being obtained corresponding to the absorptance of said at least one ink at its characteristic wavelength versus the inking level, and in case the two straight lines respectively obtained for both printers have a different slope, then a slope ratio is calculated which is equal to the slope obtained by the new printer/the slope obtained by the reference printer, which slope ratio determines the correction coefficient to be applied to said at least one ink printed by the new printer.

8. The method of claim 5, wherein the method further comprises a monitoring of the inking level of said at least one ink printed on the support by said at least one printer, according to a set print parameter defining a set inking level, the monitoring comprising reflectance parameter R measurements for said at least one ink, wherein:
the reflectance parameter R measurements being converted into measured values of the optical parameter of the at least one ink, such as said K/S ratio, to obtain a calculated equivalent inking level for said at least one ink;
an inking level ratio defining a correction factor being calculated, which is equal to the equivalent inking level for said at least one ink/the set inking level, and in case the correction factor is outside a predetermined range for said at least one ink, such as less than 0.9 or greater than 1.1, then at least a second printing of said at least one ink is carried out in the same manner and the corresponding correction factor is again determined for said at least one ink; and
if the correction factor for said at least one ink after the at least one second printing is still outside said range, then an ink cartridge of said at least one printer is replaced.

9. The method of claim 1, wherein the at least one predetermined optical property in the visible and/or invisible light domain(s) is a maximum absorptance value of the optical article, measured at at least one given wavelength of the visible and/or invisible light domain(s).

10. The method of claim 1, wherein the at least one predetermined optical property is in the visible light domain, the at least one ink comprising at least one primary color consisting of cyan and/or magenta and/or yellow (CMY), the primary color(s) being separately printed on the support, the inking level of each primary color being separately controlled.

11. The method of claim 1, wherein the at least one predetermined optical property is in the invisible light domain, and the at least one ink comprising an invisible single-component dye is selected from UV absorbers and IR absorbers for optical articles.

12. The method of claim 1, wherein the thermal transfer comprises:
(i) drying the printed support,
(ii) transferring by sublimation, by vacuum heating, the at least one dye of the at least one ink from the dried printed support onto a surface of an optical article intended to form said customized optical article, and
(iii) fixing the at least one dye into a superficial sublayer of the optical article, to form said main surface of the customized optical article.

13. The method of claim 1, wherein the least one predetermined optical property of the customized optical article only results from the inking level of the at least one ink, the method being devoid of a retouching final step such as a dip-tinting step.

14. A system for obtaining a customized optical article comprising a main surface having at least one predetermined optical property in visible and/or invisible light domain(s) selected from absorbance and transmittance, by a thermal transfer via a sublimation technique from a printed support comprising a support and at least one ink printed on the support according to an inking level, the at least one ink comprising at least one sublimable dye selected from visible dyes, invisible dyes and mixtures thereof,
wherein the system comprises at least one printer and a computer readable medium equipping or coupled to the at least one printer, the computer readable medium carrying one or more stored sequence of instructions of a computer program which is accessible to a processor and which, when executed by the processor, causes the processor to control the inking level of the at least one ink, for obtaining said customized optical article by using an experimentally determined variation law of the at least one predetermined optical property as a function of the inking level of the at least one ink.

15. The system of claim 14, wherein the system further comprises a reflection spectrophotometer configured to measure, on the printed support, a reflectance parameter R of the at least one ink, and
wherein the one or more stored sequence of instructions is configured to implement said variation law of the at least one predetermined optical property as a function of the inking level of the at least one ink, said variation law being experimentally determined by using in combination:
a first experimental correlation between an optical parameter of the at least one ink on the printed support and the inking level thereof, the optical parameter being calculated from said reflectance parameter R of the at least one ink and being selected from its K/S ratio of absorbance coefficient to scattering coefficient, its optical density, its colorimetric coefficients such as its colorimetric lightness L* and colorimetric coefficients a* and b*, and combinations thereof; and
a second experimental correlation between at least one predicted optical property of the customized optical article, selected from maximum absorbance and minimum transmittance values of the optical article and measured at at least one given wavelength of visible or invisible light domains, and said optical parameter of the at least one ink.

16. The system of claim 15, wherein:
the first experimental correlation is a linear one of the type y=a x+b, where y denotes the optical parameter of the at least one ink on the printed support, x denotes the inking level of the at least one ink, and a, b are constants; and
the second experimental correlation is a linear one of the type y=a′ x+b′, where y denotes the at least one predicted optical property of the customized optical article, x denotes the optical parameter of the at least one ink on the printed support, and a′, b′ are constants.

17. The system of claim 15, wherein the one or more stored sequence of instructions is configured to compensate the inking level for the at least one ink, by means of said first experimental correlation and available data of reference optical articles which were beforehand manufactured by said thermal transfer from a similar printed support, the available optical articles each comprising a main surface having at least one known optical property in visible and/or invisible light domain(s) similar to the at least one predetermined optical property, the available data of reference optical articles resulting from said first and second experimental correlations, and wherein the one or more stored sequence of instructions is configured to:
calculate a compensation coefficient from a reference value of the optical parameter and a measured value of the optical parameter for the at least one ink, the reference value of the optical parameter being derived from the available data of reference optical articles and corresponding to said at least one predicted optical property of the customized optical article; and
obtain a compensated inking level of the at least one ink from the calculated compensation coefficient.

18. The method of claim 12, wherein fixing the at least one dye is fixed into a superficial sublayer of the optical article, of several microns thick.
